(19) United States
(12) Patent Application Publication
(10) Pub. No.: US 2004/0203995 A1
(43) Pub. Date: Oct. 14, 2004

(54) Overturnable phone

(75) Inventor: Sergey Platonov, Moscow (RU)

Correspondence Address: SERGEY PLATONOV, 16-7 LOMONOSOVA STR., ZHUKOVSKY, MOSCOW REG., MOSCOW, 140180, RU

(73) Assignee: Mr. Serguei Platonov, Moscow (RU)

(21) Appl. No.: 10/063,312

(22) Filed: Apr. 10, 2002

(51) Int. Cl. H04M 1/00

(52) U.S. Cl. 455/550.1; 455/556.1

(57) ABSTRACT

A communicative device (cellular phone) with the ability to use in normal and upside down positions to make using of device more convenient. The technical result consists in indifference of which edge of phone is to be held upwards, is achieved by installation (on the tube) of two sets of microphone+speaker microphone of one set nearby the speaker of other set and vice versa—and a special switch for connecting the necessary set manually or automatically by a special gravity sensible switch.

### BACKGROUND OF INVENTION

The present invention relates generally to communication devices (information technologies) and, particularly, to radio transceivers” and cellular telephones” layout.

All known prior art devices mainly comprise microphone and speaker units situated on the opposite edges of a receiver on its face panel. Thus one end (edge), containing speaker, is always meant to be taken upwards, the opposite end (edge) downwards.

It sometimes causes inconvenience in use. Taking it in the wrong direction compels to make one more grasp.

### SUMMARY OF INVENTION

The technical result of the present embodiment is to make use of telephone (telecommunication device) more convenient.

This result is achieved by mounting an additional set of speaker plus microphone on the opposite edges of receiver in the counter direction layout and adding a switch to put into operation one set or another, depending on which edge is taken upwards.

### BRIEF DESCRIPTION OF DRAWINGS

The embodiment of the present invention will be described with reference to the accompanied drawing.

FIG. 1 shows schematic view of the device with two sets of microphone plus speaker located in the opposite directions. Said sets are connected to input/output circuits via gravity sensible switch.

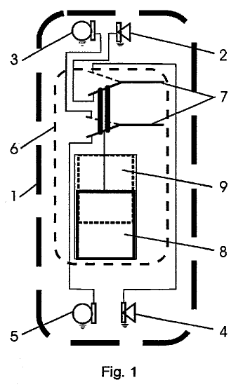

FIG. 2 shows the schematic diagram of how hysteresis function implemented into the switch helps to eliminate false switching.

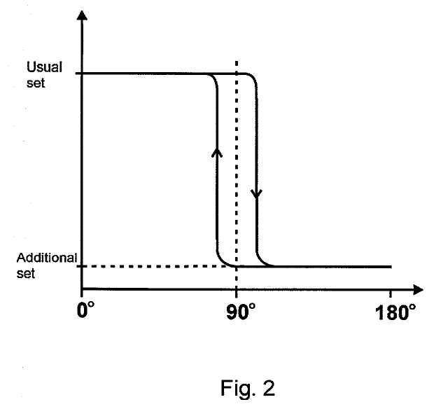

### DETAILED DESCRIPTION

The device of the present embodiment comprises the phone housing with a usual set of elements for phone functioning 1 and an additional set of speaker 3 plus microphone 4 implemented in it. Said additional set is installed in opposite orientation in relation to the usual set 2 and 5, so that said additional microphone 3 is installed near the speaker 2, and additional speaker 4 is installed near the microphone 5.

One or another set is connected to phone”

To eliminate false switching in the near horizontal orientations a slight fixation in extreme positions can be made for providing hysteresis function in operation diagram.

As gravity sensitive elements may be used the elements of the device structure (for example, battery).

Activity description.

The appliance 1 in the initially is oriented horizontally, with the switch 6 in one of two possible positions 8 or 9.

To put it into operation it is taken one end up. The switch 6, sensitive to gravity, connects the corresponding microphone+speaker set 3+4 or 2+5 to the phones circuit 7.

One or two more sets of receiving and reproduction of speech signal devices can be installed on the rear side of device.

Switching can be realized with automatic drive manual drive or both.

On putting the appliance down on horizontal surface the switch remains in previous position, due to hysteresis property. It needs a bit more extra turn to switch.

I claim:

1. A communication device, comprising:
a device for transmitting and receiving data;
a device for receiving of speech signal;
a device for reproduction of speech signal;
wherein
an additional set of speech signal receiving and reproduction devices are introduced into device together with switch to connect either regular or additional set to communicative device”
wherein
said additional device for receiving of speech signal is installed on the face side of said communicative device nearby the said regular device for reproduction of speech signal;
said additional device for reproduction of speech signal is installed on the face side of said communicative device nearby the said regular device for receiving of speech signal;
said switch put into operation regular or additional said sets depending on which edge of device is taken upwards.

2. A device of claim 1, wherein the switch has a gravity sensible drive.

3. A device of claim 1, wherein the switch has a manual drive.

4. A device of claim 1, wherein one more set of receiving and reproduction of speech signal devices is installed on the rear side of device.

5. A device of claim 4, wherein one more additional set of receiving and reproduction of speech signal devices is installed on the rear side of device.

6. A device of claims 4, 5, wherein the switch can serve all said sets of receiving and reproduction of speech signal devices.

7. A device of all a.m. claims, wherein the switch drive can be turned form manual to automatic mode and vice versa.

8. A device of all a.m. claims, wherein the switch has a hysteresis function in operation diagram.

9. A device of all a.m. claims, wherein as gravity sensitive element is used the element of the device structure.
